(19) United States
(12) Patent Application Publication
(10) Pub. No.: US 2016/0247092 A1
(43) Pub. Date: Aug. 25, 2016

(54) INFORMATION PROCESSING APPARATUS, STORAGE MEDIUM, AND INFORMATION PROCESSING METHOD

(71) Applicant: FUJI XEROX CO., LTD., Tokyo (JP)

(72) Inventor: Masao WATANABE, Yokohama-shi (JP)

(73) Assignee: FUJI XEROX CO., LTD., Tokyo (JP)

(21) Appl. No.: 15/144,301

(22) Filed: May 2, 2016

Related U.S. Application Data
(63) Continuation of application No. PCT/JP2014/072075, filed on Aug. 25, 2014.

(30) Foreign Application Priority Data
Feb. 6, 2014 (JP) 2014-021033

(51) Int. Cl. G06N 99/00; G06F 17/50

(52) U.S. Cl. CPC G06N 99/005; G06F 17/50

(57) ABSTRACT

An information processing apparatus includes a structuring unit and an extraction unit. The structuring unit structures a history of operations performed in product development into a structure including at least subject information, subject attribute information, target information, target attribute information, and environment information. The extraction unit extracts knowledge about the operations by performing machine learning based on the structured history.

### CROSS REFERENCE TO RELATED APPLICATION

This is a continuation of International Application No. PCT/JP2014/072075 filed on Aug. 25, 2014, and claims priorities from Japanese Patent Application No. 2014-021033, filed on Feb. 6, 2014.

### BACKGROUND

### Technical Field

The present invention relates to an information processing apparatus, a storage medium, and an information processing method.

### SUMMARY

According to an aspect of the present invention, there is provided an information processing apparatus including a structuring unit and an extraction unit. The structuring unit structures a history of operations performed in product development into a structure including at least subject information, subject attribute information, target information, target attribute information, and environment information. The extraction unit extracts knowledge about the operations by performing machine learning based on the structured history.

### BRIEF DESCRIPTION OF DRAWINGS

Exemplary embodiment(s) of the present invention will be described in detail based on the following figures, wherein:

FIG. 1 is a schematic module configuration diagram of an example of a configuration of a present exemplary embodiment;

FIG. 2 is an illustrative diagram illustrating an example of the configuration of a system in the case where the present exemplary embodiment is realized;

FIG. 3 is a flowchart illustrating an example of a process according to the present exemplary embodiment;

FIG. 4 is an illustrative diagram illustrating an example of a log class data structure;

FIG. 5 is an illustrative diagram illustrating an example of a log instance data structure;

FIG. 6 is an illustrative diagram illustrating an example of a target information class data structure;

FIG. 7 is an illustrative diagram illustrating an example of a target information instance data structure;

FIG. 8 is an illustrative diagram illustrating an example of a product class data structure;

FIG. 9 is an illustrative diagram illustrating an example of a product instance data structure;

FIG. 10 is an illustrative diagram illustrating an example of mapping performed between a log and a class;

FIG. 11 is an illustrative diagram illustrating an example of mapping performed between a log and a class;

FIG. 12 is an illustrative diagram illustrating an example of a specific knowledge structure; and

FIG. 13 is a block diagram illustrating an example of a hardware configuration of a computer that realizes a present exemplary embodiment;

### DETAILED DESCRIPTION

First, before present exemplary embodiments are explained, their premise or an information processing apparatus that uses a present exemplary embodiment will be explained. Note that an object of this explanation is to facilitate understanding of the present exemplary embodiments.

In a product design operation, it is necessary to access many tools and various types of data. In order to handle these tools and data, professional knowledge and know-how are needed. Depending on the skills of developers, handling of these tools and data varies. Previously, since a design margin was large, product development was possible even with such variations.

However, since the development speed has been increased and the cost has been reduced in recent years, the reality is that the size of a design margin is significantly reduced and individual developers are expected to have various kinds of design knowledge and know-how. Accumulation and reuse of these various kinds of design knowledge and know-how are described in the above-described patent documents.

However, since the above-described tools and the like are changed and also a product line-up, functions, parts, and the like are changed with time, fixed knowledge becomes obsolete.

In the following, an example of a preferable exemplary embodiment for realizing the present invention will be explained in accordance with the drawings.

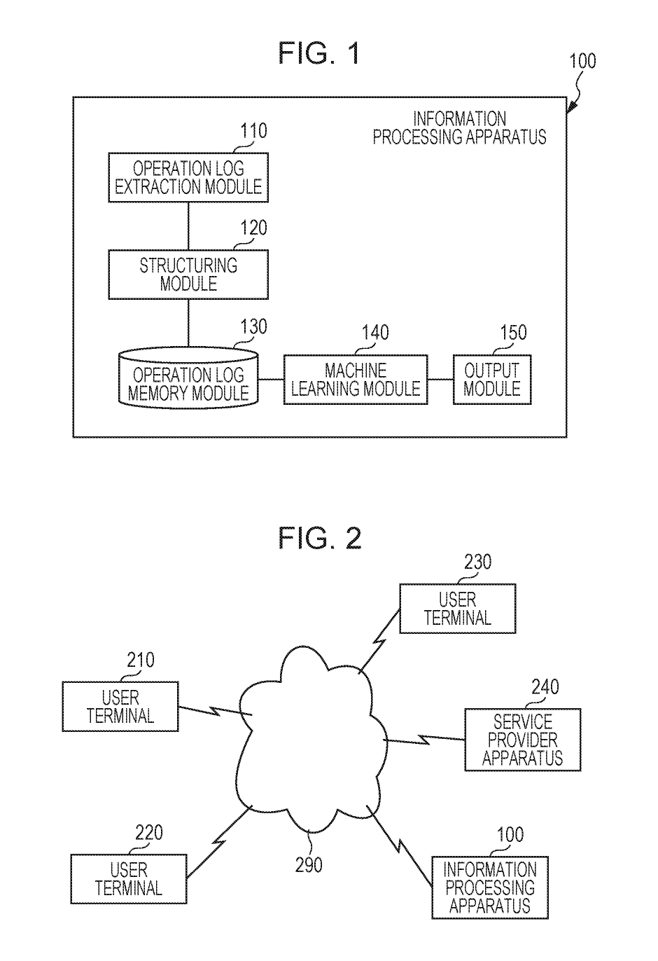

FIG. 1 illustrates a schematic module configuration diagram of an example of a configuration of the present exemplary embodiment.

Note that modules generally refer to parts that are logically separable such as software (computer programs), hardware, and the like. Thus, modules in the present exemplary embodiment refer not only to modules in a computer program but also modules in a hardware configuration. Thus, the present exemplary embodiment also explains computer programs that function as these modules (a program for causing a computer to execute each procedure, a program for causing a computer to function as each means, and a program for causing a computer to realize each function), a system, and a method. Note that, for convenience's sake in terms of explanation, “store”, “cause . . . to store” and similar expressions are used. These expressions mean that, in the case where an exemplary embodiment is a computer program, cause a storage device to store or performs control such that a storage device is caused to store . . . . There may be a one-to-one correspondence between modules and functions. When modules are mounted, one module may be configured by one program or plural modules may be configured by one program. Alternatively, one module may be configured by plural programs. Moreover, plural modules may be executed by one computer or one module may be executed by plural computers, which are computers in a distributed environment or a parallel processing environment. Note that one module may include another module. In addition, in the following, “connection” may be used not only for a physical connection but also for a logical connection (transmitting/receiving of data, instructions, a reference relationship between data, and the like). “Predetermined” means something is determined before a target process is performed, and also means that something is determined not only before a process according to the present exemplary embodiment starts but also after the process according to the present exemplary embodiment starts and before a target process starts, depending on a status or a state at that point in time or in accordance with a status or a state until that point in time. In the case where there are plural “predetermined values”, the predetermined values may differ from one another or two or more of the predetermined values (as a matter of course, including all the predetermined values) may be the same. In addition, a description meaning “in the case of A, B is performed” is used to mean that “It is determined whether or not . . . is A. In the case where it is determined that . . . is A, B is performed”. Note that cases where a determination as to whether or not . . . is A is unnecessary are excluded.

In addition, a system or an apparatus may not only be configured by plural computers, hardware devices, apparatuses, and the like connected by communication means such as a network (including one-to-one correspondence communication connection) but also be realized by one computer, a hardware device, an apparatus, or the like. An “apparatus” and a “system” are used as words having the same meaning. As a matter of course, the “system” does not include just a social “mechanism” (a social system), which is man-made arrangements.

For each process performed by each module or for each process in the case where plural processes are performed in a module, target information is read from a storage device. After the process is performed, a processing result is written into the storage device. Thus, an explanation may be omitted for reading target information from the storage device before a process is performed and an explanation may be omitted for writing target information into the storage device after a process is performed. Note that here a storage device may include a hard disk, a random access memory (RAM), an external storage medium, a storage device connected through a communication line, a register in a central processing unit (CPU), and the like.

An information processing apparatus 100, which is the present exemplary embodiment, collects knowledge about operations performed in product development. As illustrated in an example of in FIG. 1, the information processing apparatus 100 includes an operation log extraction module 110, a structuring module 120, an operation log memory module 130, a machine learning module 140, and an output module 150.

The operation log extraction module 110 is connected to the structuring module 120. The operation log extraction module 110 extracts operations performed by an operator who is involved in product development as a history (hereinafter also referred to as a log). For example, an operation of a user interface device (a keyboard, a mouse, a touch panel, a display, or the like) that the operator uses may be detected, or an instruction to an apparatus, which provides service, may also be detected. Specific examples of log information include a web access log, access control information, printer access information, e-mail transmission-reception information, and the like, and a combination of these pieces of information.

The structuring module 120 is connected to the operation log extraction module 110 and the operation log memory module 130. The structuring module 120 structures a history of operations performed in product development into a structure including at least subject information, subject attribute information, target information, target attribute information, and environment information. In addition, the structuring module 120 may also perform structuring using an ontology and a temporary rule. In addition, the structuring module 120 may also perform structuring such that information indicating whether or not a first operator, who is a subject, is able to access a target is included. Here, as a structuring method, mapping using an ontology, which is a knowledge system, may also be used. As mapping, a reasoner for ontologies, which is a known technology, or mapping using rules (rules) may also be used.

The operation log memory module 130 is connected to the structuring module 120 and the machine learning module 140. The operation log memory module 130 stores a history of operations structured by the structuring module 120.

The machine learning module 140 is connected to the operation log memory module 130 and the output module 150. The machine learning module 140 extracts knowledge about operations by performing machine learning in accordance with a history structured by the structuring module 120 (a history stored in the operation log memory module 130). In addition, in the case where the machine learning module 140 extracts knowledge to be provided to a second operator, who differs from the first operator, the machine learning module 140 may extract knowledge from the structured history such that a relationship with a target that the second operator is unable to access is not included. As extraction of knowledge through machine learning, any one of or a combination of an ontology, a mapping process using rules, and a statistical process may be used. For example, candidates are extracted by a reasoner for ontologies, some are selected from the candidates by a rule, and furthermore the some of the candidates may be prioritized by a statistical process. The statistical process may be any one of or a combination of decision tree analysis, hidden Markov model analysis, neuron model analysis, support vector machine analysis, naive Bayes analysis, and the k-Nearest Neighbors algorithm.

In addition, information used as ontologies is constituted by any one of or a combination of some of configuration information, organization information, access policy information, design-and-development process information, failure information, reliability information, regulatory constraint information, and simulation information on a product, which is a development target. In addition, rules are constituted by any one of or a combination of some of configuration information, organization information, access policy information, design-and-development process information, failure information, reliability information, regulatory constraint information, and simulation information on a target apparatus. In addition, a user context may be generated using an operator's access control information, an ontology, a rule, and a statistical engine.

The output module 150 is connected to the machine learning module 140. The output module 150 receives knowledge about operations, the knowledge being extracted by the machine learning module 140, and outputs the knowledge (information). Output of knowledge (information) includes, for example, displaying the knowledge on a display device such as a display, writing the knowledge into a storage device such as a knowledge database or the like, storing the knowledge in a storage medium such as a memory card or the like, transmitting the knowledge to another information processing apparatus, and the like.

FIG. 2 is an illustrative diagram illustrating an example of the configuration of a system in the case where the present exemplary embodiment is realized.

The information processing apparatus 100, a user terminal 210, a user terminal 220, a user terminal 230, and a service provider apparatus 240 are connected to each other via communication lines 290. A user uses service (a tool, a program) provided by the service provider apparatus 240, by using a browser or the like installed in the user terminal 210. The operation log extraction module 110 of the information processing apparatus 100 extracts operations in the service from the user terminal 210 and the like and the service provider apparatus 240 and records the operations as a history. Note that the service provider apparatus 240 may be one of service provider apparatuses 240 of plural types. Then, the user accesses various types of data using various types of service and performs design. The communication lines 290 may be wireless, wired, or a combination of wireless and wired lines and may be, for example, the Internet serving as a communication infrastructure.

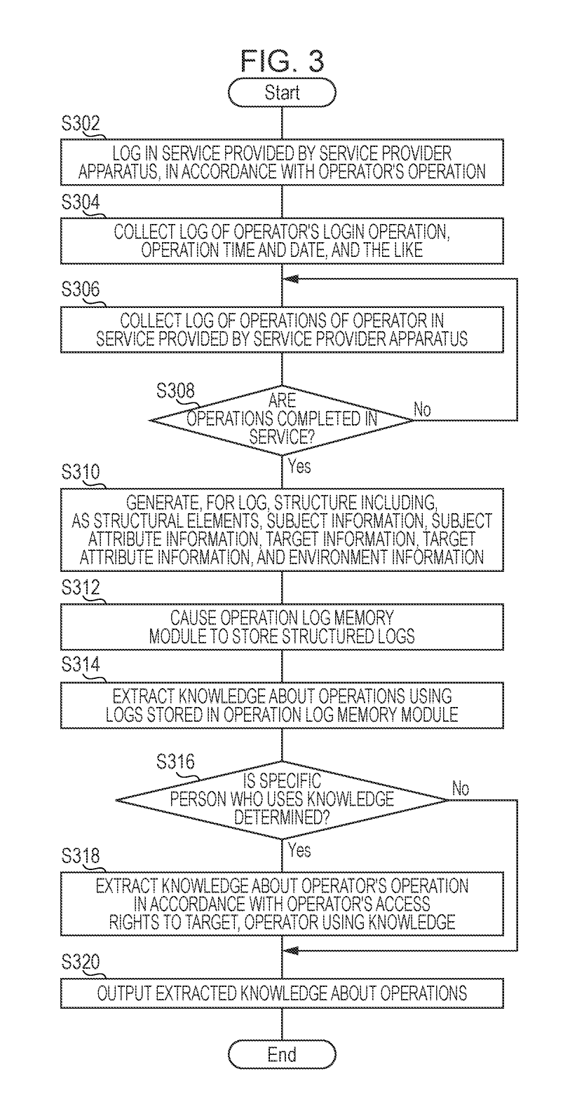

FIG. 3 is a flowchart illustrating an example of a process according to the present exemplary embodiment.

In step S302, the user terminal 210 logs in service provided by the service provider apparatus 240, in accordance with an operator's operation.

In step S304, the operation log extraction module 110 collects a log of the operator's login operation, an operation time and date, and the like.

In step S306, the operation log extraction module 110 collects a log of operations of the operator in the service provided by the service provider apparatus 240.

In step S308, the operation log extraction module 110 determines whether or not operations are completed in the service. In the case where the operations are completed, the process proceeds to step S310. Otherwise, the process returns to step S306.

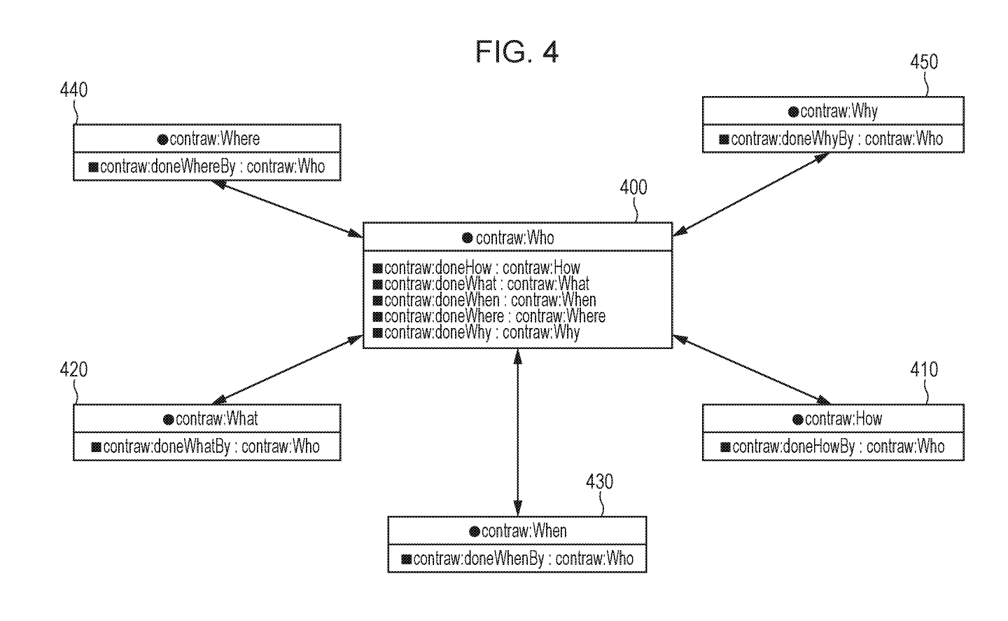

In step S310, for the log, the structuring module 120 generates a structure including, as structural elements, subject information, subject attribute information, target information, target attribute information, and environment information. For example, an example of a data structure as illustrated in FIG. 4 is generated. This illustrates an object-oriented class definition. Contraw:Who 400 is connected to contraw:How 410, contraw:What 420, contraw:When 430, contraw:Where 440, and contraw:Why 450. This connection is a two-way link. The subject information is defined as contraw:Who 400. The subject attribute information is defined as contraw:Why 450. The target information and the target attribute information are defined as contraw:What 420. The environment information is defined as contraw:How 410, contraw:When 430, and contraw:Where 440. The subject information corresponds to information (a user ID (IDentification) or the like) for determining the operator, and the subject attribute information corresponds to a group (organization) to which the operator belongs and the position, the access rights, and the like of the operator. The target information corresponds to a target of the operation and includes a drawing, a technical specification, a design sheet, a design review document, or an official document such as regulations, rules, and the like (a document ID or the like), a part, assembly information, and the like. The target attribute information corresponds to a creation time and date and a creator of a document, user IDs that are able to access the document, and the like. The environment information corresponds to a system that operates the document (contraw:Where 440), a time and date at which an operation is performed (contraw:When 430), an operation in the system (contraw:How 410), and the like.

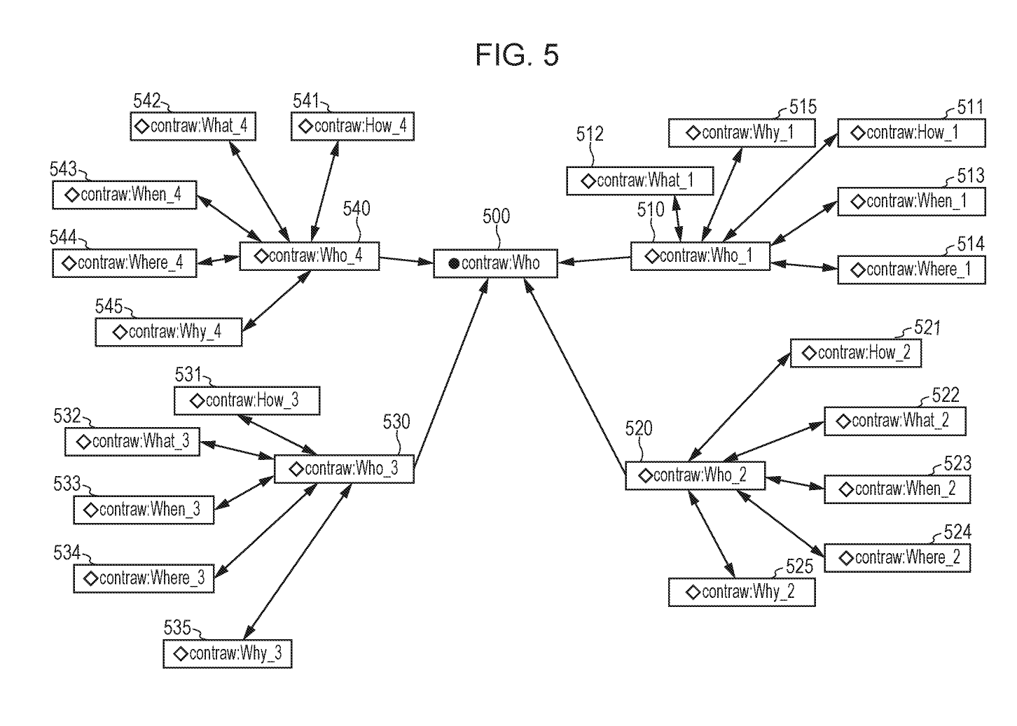

An example of the case where logs are applied on the basis of the class illustrated in FIG. 4 is illustrated in FIG. 5. This is obtained by mapping the logs on the class and an instance is generated. Contraw:Who 500 is connected to contraw:Who_1: 510, contraw:Who_2: 520, contraw:Who_3: 530, and contraw:Who_4: 540. Contraw:Who_1: 510 is connected to contraw:Who 500, contraw:How_1: 511, contraw:What_1: 512, contraw:When_1: 513, contraw:Where_1: 514, and contraw:Why_1: 515. Contraw:Who_2: 520 is connected to contraw:Who 500, contraw:How_2: 521, contraw:What_2: 522, contraw:When_2: 523, contraw:Where_2: 524, and contraw:Why_2: 525. Contraw:Who_3: 530 is connected to contraw:Who 500, contraw:How_3: 531, contraw:What_3: 532, contraw:When_3: 533, contraw:Where_3: 534, and contraw:Why_3: 535. Contraw:Who_4: 540 is connected to contraw:Who 500, contraw:How_4: 541, contraw:What_4: 542, contraw:When_4: 543, contraw:Where_4: 544, and contraw:Why_4: 545. Note that contraw:Who 500 serves as a route and is linked to the subject information of all the logs. Each of contraw:Who_1: 510, contraw:Who_2: 520, contraw:Who_3: 530, and contraw:Who_4: 540 illustrates the subject information of a corresponding one of the logs.

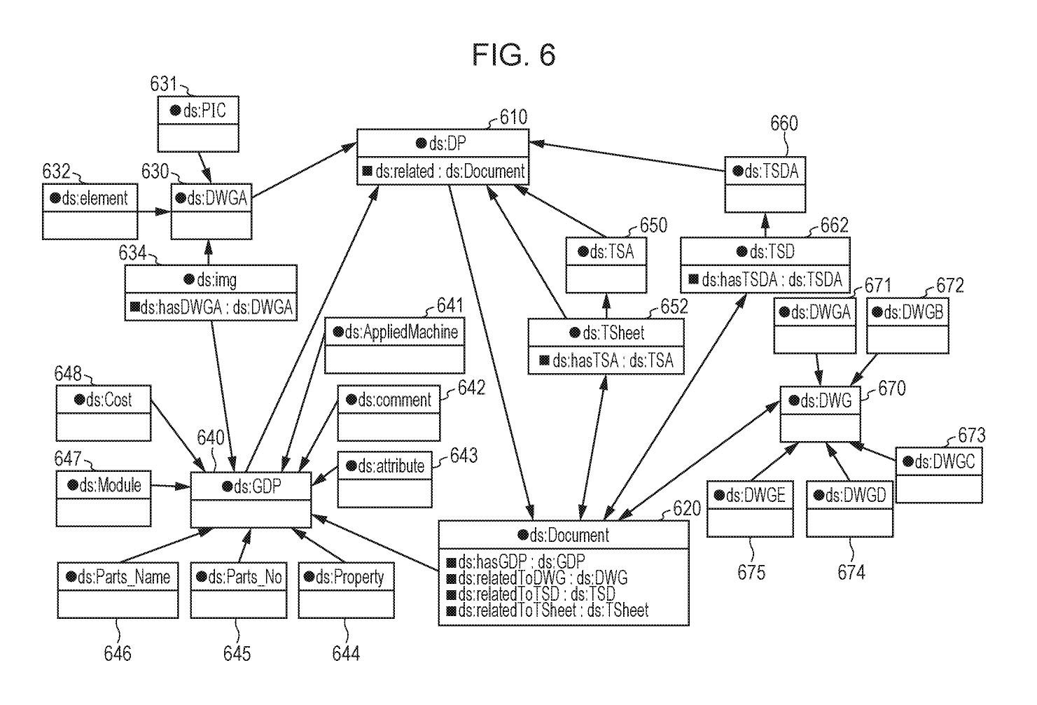

In addition, for example, an example of a data structure as illustrated in FIG. 6 is generated for the target information. This illustrates an object-oriented class definition. Ds:DP 610 is connected to ds:Document 620, ds:DWGA 630, ds:GDP 640, ds:TSA 650, ds:Tsheet 652, and ds:TSDA 660. Ds:Document 620 is connected to ds:DP 610, ds:GDP 640, ds:TSheet 652, ds:TSD 662, and ds:DWG 670. Ds:DWGA 630 is connected to ds:DP 610, ds:PIC 631, ds:element 632, and ds:img 634. Ds:PIC 631 is connected to ds:DWGA 630. Ds:element 632 is connected to ds:DWGA 630. Ds:img 634 is connected to ds:DWGA 630 and ds:GDP 640. Ds:GDP 640 is connected to ds:DP 610, ds:Document 620, ds:img 634, ds:AppliedMachine 641, ds:comment 642, ds:attribute 643, ds:Property 644, ds:Parts_No 645, ds:Parts_Name 646, ds:Module 647, and ds:Cost 648. Ds:AppliedMachine 641 is connected to ds:GDP 640. Ds:comment 642 is connected to ds:GDP 640. Ds:attribute 643 is connected to ds:GDP 640. Ds:Property 644 is connected to ds:GDP 640. Ds:Parts_No 645 is connected to ds:GDP 640. Ds:Parts_Name 646 is connected to ds:GDP 640. Ds:Module 647 is connected to ds:GDP 640. Ds:Cost 648 is connected to ds:GDP 640. Ds:TSA 650 is connected to ds:DP 610 and ds:TSheet 652. Ds:TSheet 652 is connected to ds:DP 610, ds:TSA 650, and ds:Document 620. Ds:TSDA 660 is connected to ds:DP 610 and ds:TSD 662. Ds:TSD 662 is connected to ds:TSDA 660 and ds:Document 620. Ds: DWG 670 is connected to ds:Document 620, ds:DWGA 671, ds:DWGB 672, ds:DWGC 673, ds:DWGD 674, and ds:DWGE 675. Ds:DWGA 671 is connected to ds:DWG 670. Ds:DWGB 672 is connected to ds:DWG 670. Ds:DWGC 673 is connected to ds:DWG 670. Ds:DWGD 674 is connected to ds:DWG 670. Ds:DWGE 675 is connected to ds:DWG 670. These illustrate documents such as design drawings or the like. Structures constituted by ds:DWGA 630 and ds:GDP 640 illustrate classes of the target attribute information. Then, structures constituted by ds:TSA 650, ds:TSDA 660, and ds:DWG 670 illustrate classes of documents (ds:TSA 650 corresponding to a trouble sheet, ds:TSDA 660 corresponding to a technical guideline, and ds:DWG 670 corresponding to a CAD system) for generating the target or the like.

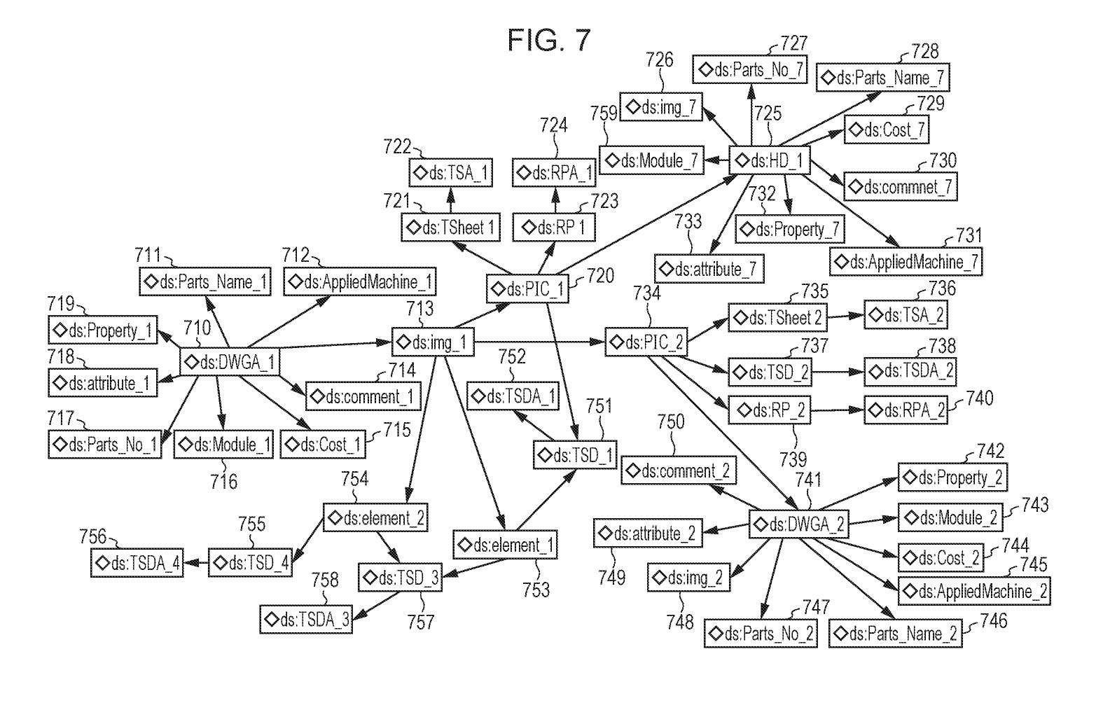

An example of the case where logs are applied on the basis of the classes illustrated in FIG. 6 is illustrated in FIG. 7. This is obtained by mapping the logs on the classes and an instance is generated. Ds:DWGA_1: 710 is connected to ds:Parts_Name_1: 711, ds:AppliedMachine_1: 712, ds:img_1: 713, ds:comment_1: 714, ds:Cost_1: 715, ds:Module_1: 716, ds:Parts_No_1: 717, ds:attribute_1: 718, and ds:Property_1: 719. Ds:Parts_Name_1: 711 is connected to ds:DWGA_1: 710. Ds:AppliedMachine_1: 712 is connected to ds:DWGA_1: 710. Ds:img_1: 713 is connected to ds:DWGA_1: 710, ds:PIC_1: 720, ds:PIC_2: 734, ds:element_1: 753, and ds:element_2: 754. Ds:comment_1: 714 is connected to ds:DWGA_1: 710. Ds:Cost_1: 715 is connected to ds:DWGA_1: 710. Ds:Module_1: 716 is connected to ds:DWGA_1: 710. Ds:Parts_No_1: 717 is connected to ds:DWGA_1: 710. Ds:attribute_1: 718 is connected to ds:DWGA_1: 710. Ds:Property_1: 719 is connected to ds:DWGA_1: 710. Ds:PIC_1: 720 is connected to ds:img_1: 713, ds:TSheet_1: 721, ds:RP_1: 723, ds:HD_1: 725, and ds:TSD_1: 751. Ds:TSheet_1: 721 is connected to ds:PIC_1: 720 and ds:TSA_1: 722. Ds:TSA_1: 722 is connected to ds:TSheet_1: 721. Ds:RP_1: 723 is connected to ds:PIC_1: 720 and ds:RPA_1: 724. Ds:RPA_1: 724 is connected to ds:RP_1: 723. Ds:HD_1: 725 is connected to ds:PIC_1: 720, ds:img_7: 726, ds:Parts_No_7: 727, ds:Parts_Name_7: 728, ds:Cost_7: 729, ds:comment_7: 730, ds:AppliedMachine_7: 731, ds:Property_7: 732, ds:attribute_7: 733, and ds:Module_7: 759. Ds:img_7: 726 is connected to ds:HD_1: 725. Ds:Parts_No_7: 727 is connected to ds:HD_1: 725. Ds:Parts_Name_7: 728 is connected to ds:HD_1: 725. Ds:Cost_7: 729 is connected to ds:HD_1: 725. Ds:comment_7: 730 is connected to ds:HD_1: 725. Ds:AppliedMachine_7: 731 is connected to ds:HD_1: 725. Ds:Property_7: 732 is connected to ds:HD_1: 725. Ds:attribute_7: 733 is connected to ds:HD_1: 725. Ds:PIC_2: 734 is connected to ds:img_1: 713, ds:TSheet_2: 735, ds:TSD_2: 737, ds:RP_2: 739, and ds:DWGA_2: 741. Ds:TSheet_2: 735 is connected to ds:PIC_2: 734 and ds:TSA_2: 736. Ds:TSA_2: 736 is connected to ds:TSheet_2: 735. Ds:TSD_2: 737 is connected to ds:PIC_2: 734 and ds:TSDA_2: 738. Ds:TSDA_2: 738 is connected to ds:TSD_2: 737. Ds:RP_2: 739 is connected to ds:PIC_2: 734 and ds:RPA_2: 740. Ds:RPA_2: 740 is connected to ds:RP_2: 739. Ds:DWGA_2: 741 is connected to ds:PIC_2: 734, ds:Property_2: 742, ds:Module_2: 743, ds:Cost_2: 744, ds:AppliedMachine_2: 745, ds:Parts_Name_2: 746, ds:Parts_No_2: 747, ds:img_2: 748, ds:attribute_2: 749, and ds:comment_2: 750. Ds:Property_2: 742 is connected to ds:DWGA_2: 741. Ds:Module_2: 743 is connected to ds:DWGA_2: 741. Ds:Cost_2: 744 is connected to ds:DWGA_2: 741. Ds:AppliedMachine_2: 745 is connected to ds:DWGA_2: 741. Ds:Parts_Name_2: 746 is connected to ds:DWGA_2: 741. Ds:Parts_No_2: 747 is connected to ds:DWGA_2: 741. Ds:img_2: 748 is connected to ds:DWGA_2: 741. Ds:attribute_2: 749 is connected to ds:DWGA_2: 741. Ds:comment_2: 750 is connected to ds:DWGA_2: 741. Ds:TSD_1: 751 is connected to ds:PIC_1: 720, ds:TSDA_1: 752, and ds:element_1: 753. Ds:TSDA_1: 752 is connected to ds:TSD_1: 751. Ds:element_1: 753 is connected to ds:img_1: 713, ds:TSD_1: 751, and ds:TSD_3: 757. Ds:element_2: 754 is connected to ds:img_1: 713, ds:TSD_4: 755, and ds:TSD_3: 757. Ds:TSD_4: 755 is connected to ds:element_2: 754 and ds:TSDA_4: 756. Ds:TSDA_4: 756 is connected to ds:TSD_4: 755. Ds:TSD_3: 757 is connected to ds:element_1: 753, ds:element_2: 754, and ds:TSDA_3: 758. Ds:TSDA_3: 758 is connected to ds:TSD_3: 757. Ds:Module_7: 759 is connected to ds:HD_1: 725.

In step S312, the structuring module 120 causes the operation log memory module 130 to store structured logs.

In step S314, the machine learning module 140 extracts knowledge about the operations using the logs stored in the operation log memory module 130. Specifically, know-how information is extracted from the structured logs within the operation log memory module 130 by using an engine that performs an inference process (an ontology, a mapping process using rules, a statistical process).

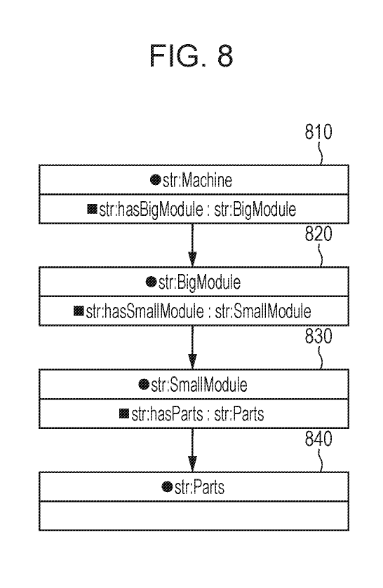

FIG. 8 is an illustrative diagram illustrating an example of a product class data structure. The relationship between a module structure and parts of a product is illustrated. Str:Machine 810 is connected to str:BigModule 820. Str:BigModule 820 is connected to str:Machine 810 and str:SmallModule 830. Str:SmallModule 830 is connected to str:BigModule 820 and str:Parts 840. Str:Parts 840 is connected to str:SmallModule 830. These are a class indicating that the product is constituted by a large module, the large module is constituted by a small modules and the small module is constituted by parts.

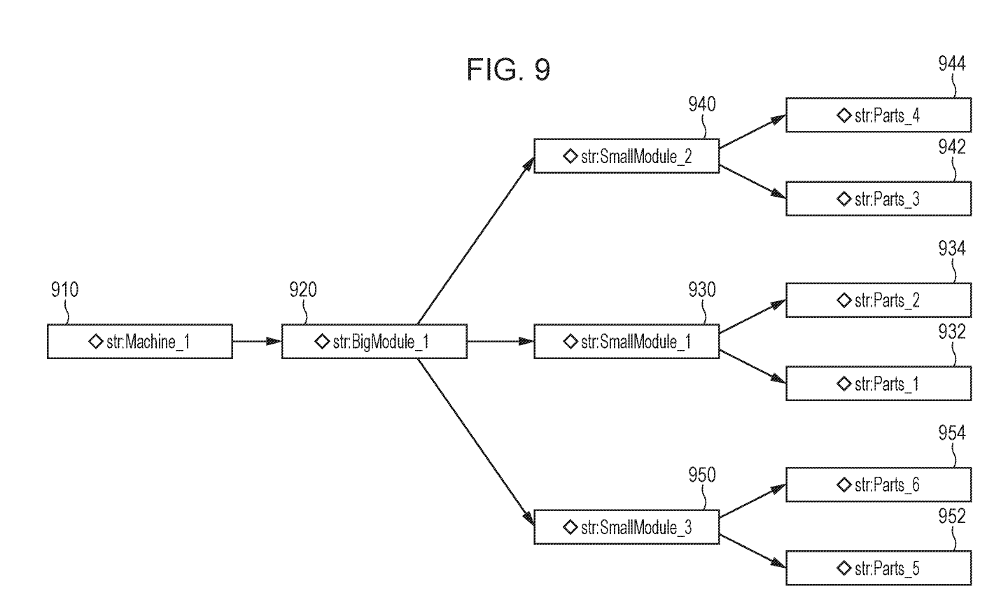

FIG. 9 is an illustrative diagram illustrating an example of a product instance data structure. An instance is illustrated in the case where the class illustrated in the example of FIG. 8 is applied to an actual product. This is used as an ontology. Str:Machine_1: 910 is connected to str:BigModule_1: 920. Str:BigModule_1: 920 is connected to str:Machine_1: 910, str:SmallModule_1: 930, str:SmallModule_2: 940, and str:SmallModule_3: 950. Str:SmallModule_1: 930 is connected to str:BigModule_1: 920, str:Parts_1: 932, and str:Parts_2: 934. Str:SmallModule_2: 940 is connected to str:BigModule_1: 920, str:Parts_3: 942, and str:Parts_4: 944. Str:SmallModule_3: 950 is connected to str:BigModule_1: 920, str:Parts_5: 952, and str:Parts_6: 954.

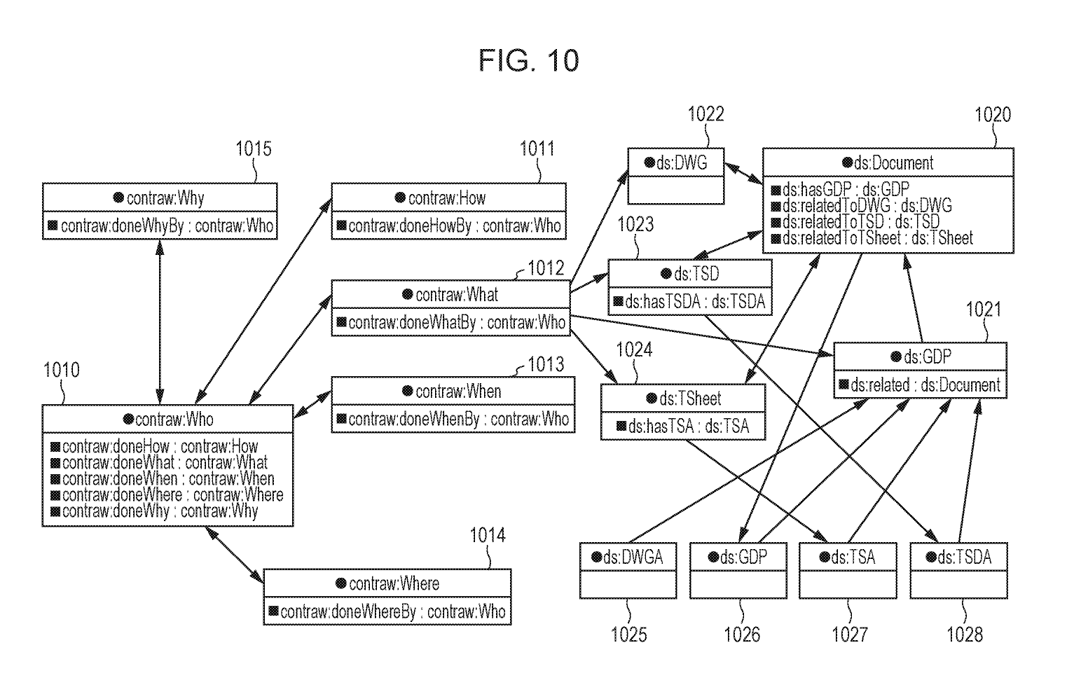

Then, mapping is performed between a structured log and a predetermined class. FIG. 10 is an illustrative diagram illustrating an example of mapping performed between a log and a class. Contraw:Who 1010, contraw:Why 1015, and the like on the left side of the drawing represent a class that is a mapping target, and ds:Document 1020, ds:DWG 1022, and the like on the right side of the drawing represent a structured log. Contraw:Who 1010 is connected to contraw:How 1011, contraw:What 1012, contraw:When 1013, contraw:Where 1014, and contraw:Why 1015. Contraw:How 1011 is connected to contraw:Who 1010. Contraw:What 1012 is connected to contraw:Who 1010. Contraw:When 1013 is connected to contraw:Who 1010. Contraw:Where 1014 is connected to contraw:Who 1010. Contraw:Why 1015 is connected to contraw:Who 1010. Ds:Document 1020 is connected to ds:GDP 1021, ds:DWG 1022, ds:TSD 1023, ds:TSheet 1024, and ds:GDP 1026. Ds:GDP 1021 is connected to ds:Document 1020, ds:DWGA 1025, ds:GDP 1026, ds:TSA 1027, and ds:TSDA 1028. Ds:DWG 1022 is connected to ds:Document 1020. Ds:TSD 1023 is connected to ds:Document 1020 and ds:TSDA 1028. Ds:TSheet 1024 is connected to ds:Document 1020 and ds:TSA 1027. Ds:DWGA 1025 is connected to ds:GDP 1021. Ds:GDP 1026 is connected to ds:Document 1020 and ds:GDP 1021. Ds:TSA 1027 is connected to ds:GDP 1021 and ds:TSheet 1024. Ds:TSDA 1028 is connected to ds:GDP 1021 and ds:TSD 1023.

Then, as a result of mapping, contraw:What 1012 corresponds to ds:GDP 1021, ds:DWG 1022, ds:TSD 1023, and ds:TSheet 1024. In mapping here, a reasoner for ontologies or the like is used as described above. In addition, the class on the left side may also be defined as an ontology. In addition, a rule that coupling is realized only under certain specific conditions may be used.

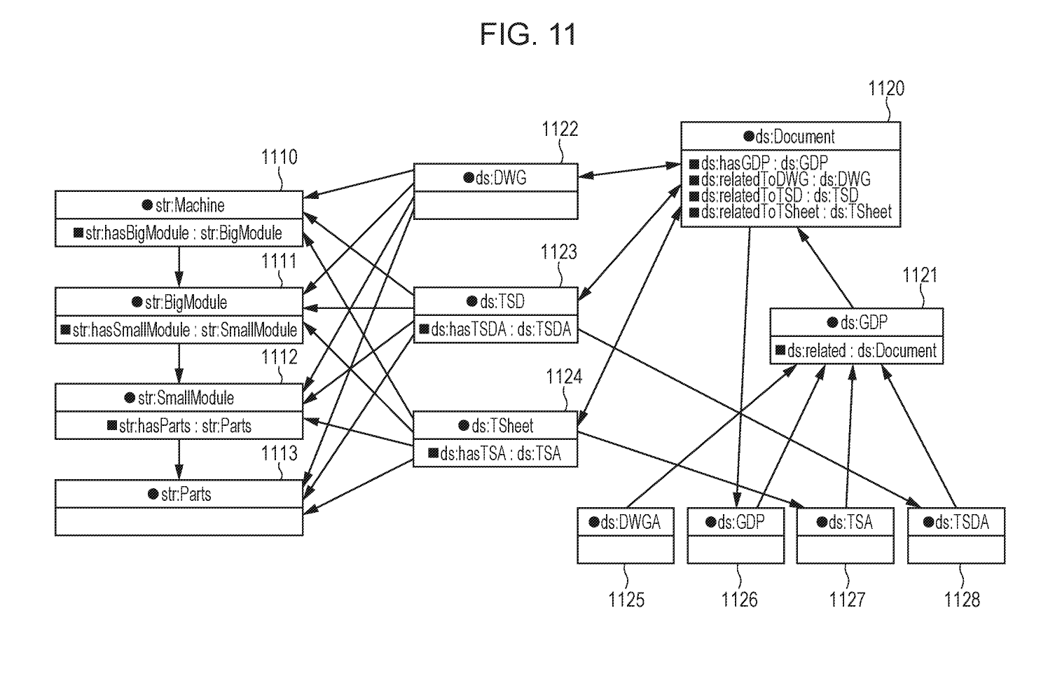

In addition, mapping may also be performed between a structured log and a class indicating a product configuration. FIG. 11 is an illustrative diagram illustrating an example of mapping performed between a log and a class. Str:Machine 1110, str:SmallModule 1112, and the like on the left side of the drawing represent a class indicating the configuration of a product that is a mapping target, and ds:Document 1120, ds:DWG 1122, and the like on the right side of the drawing represent a structured log. Str:Machine 1110 is connected to str:BigModule 1111. Str:BigModule 1111 is connected to str:Machine 1110 and str:SmallModule 1112. Str:SmallModule 1112 is connected to str:BigModule 1111 and str:Parts 1113. Str:Parts 1113 is connected to str:SmallModule 1112. Ds:Document 1120 is connected to ds:GDP 1121, ds:DWG 1122, ds:TSD 1123, ds:TSheet 1124, and ds:GDP 1126. Ds:GDP 1121 is connected to ds:Document 1120, ds:DWGA 1125, ds:GDP 1126, ds:TSA 1127, and ds:TSDA 1128. Ds:DWG 1122 is connected to ds:Document 1120. Ds:TSD 1123 is connected to ds:Document 1120 and ds:TSDA 1128. Ds:TSheet 1124 is connected to ds:Document 1120 and ds:TSA 1127. Ds:DWGA 1125 is connected to ds:GDP 1121. Ds:GDP 1126 is connected to ds:Document 1120 and ds:GDP 1121. Ds:TSA 1127 is connected to ds:GDP 1121 and ds:TSheet 1124. Ds:TSDA 1128 is connected to ds:GDP 1121 and ds:TSD 1123.

Then, as a result of mapping, ds:DWG 1122 corresponds to str:Machine 1110, str:BigModule 1111, str:SmallModule 1112, and str:Parts 1113. Ds:TSD 1123 corresponds to str:Machine 1110, str:BigModule 1111, str:SmallModule 1112, and str:Parts 1113. Ds:TSheet 1124 corresponds to str:Machine 1110, str:BigModule 1111, str:SmallModule 1112, and str:Parts 1113. In mapping here, a reasoner for ontologies or the like is used as described above. In addition, the class on the left side may also be defined as an ontology. In addition, a rule that coupling is realized only under certain specific conditions may be used.

In step S316, the machine learning module 140 determines whether or not a specific person who uses the knowledge is determined. In the case where such a specific person is determined, the process proceeds to step S318. Otherwise, the process proceeds to step S320. For determination of a specific person who uses knowledge, a user ID or the like of a logged-in person has only to be determined. In the case where such a specific person is not determined, general knowledge (the knowledge extracted in step S314) is simply output in step S320.

In step S318, the machine learning module 140 extracts knowledge about the operator's operation in accordance with the operator's access rights to a target, the operator using knowledge. For example, knowledge extracted from logs is constituted by information on logs that a subject is able to access. There may be a case where a certain document that may be accessed by some persons who use knowledge may not be accessed by other persons who use knowledge. Thus, knowledge has only to be extracted from structured logs such that relationships with targets that an operator who uses knowledge is unable to access are not included.

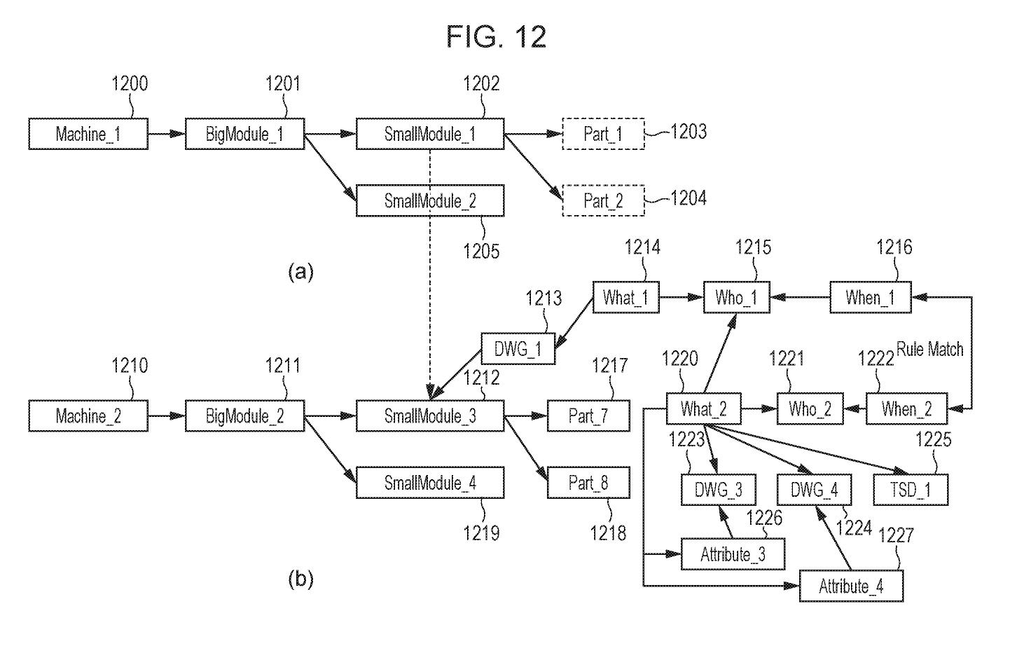

In step S320, the output module 150 outputs the extracted knowledge about the operations. FIG. 12 is an illustrative diagram illustrating an example of a specific knowledge structure (a mapping example). A class illustrated in the example of part (a) of FIG. 12 represents a class of a product that is a development target. Machine_1: 1200 is connected to BigModule_1: 1201. BigModule_1: 1201 is connected to Machine_1: 1200, SmallModule_1: 1202, and SmallModule_2: 1205. SmallModule_1: 1202 is connected to BigModule_1: 1201, Part_1: 1203, and Part_2: 1204. Part 1: 1203 is connected to SmallModule_1: 1202. Part_2: 1204 is connected to SmallModule_1: 1202. SmallModule_2: 1205 is connected to BigModule_1: 1201.

Then, what illustrated in the example of part (b) of FIG. 12 is something that has already been structured as a log. Machine_2: 1210 is connected to BigModule_2: 1211. BigModule_2: 1211 is connected to Machine_2: 1210, SmallModule_3: 1212, and SmallModule_4: 1219. SmallModule_3: 1212 is connected to BigModule_2: 1211, DWG_1: 1213, Part_7: 1217, and Part_8: 1218. DWG_1: 1213 is connected to SmallModule_3: 1212, and What_1: 1214. What 1: 1214 is connected to DWG_1: 1213 and Who_1: 1215. Who_1: 1215 is connected to What 1: 1214, When_1: 1216, and What_2: 1220. When_1: 1216 is connected to Who_1: 1215 and When_2: 1222. Part_7: 1217 is connected to SmallModule_3: 1212. Part_8: 1218 is connected to SmallModule_3: 1212. SmallModule_4: 1219 is connected to BigModule_2: 1211. What_2: 1220 is connected to Who_1: 1215, Who_2: 1221, DWG_3: 1223, DWG_4: 1224, TSD_1: 1225, Attribute_3: 1226, and Attribute_4: 1227. Who_2: 1221 is connected to What_2: 1220, and When_2: 1222. When_2: 1222 is connected to When_1: 1216 and Who_2: 1221. DWG_3: 1223 is connected to What_2: 1220 and Attribute_3: 1226. DWG_4: 1224 is connected to What_2: 1220 and Attribute_4: 1227. TSD 1: 1225 is connected to What_2: 1220. Attribute_3: 1226 is connected to What_2: 1220 and DWG_3: 1223. Attribute_4: 1227 is connected to What_2: 1220 and DWG_4: 1224.

Here, SmallModule_1: 1202 illustrated in the example of part (a) of FIG. 12 is a module of the product that is the development target for an operator. As a result of mapping, it is determined that SmallModule_1: 1202 corresponds to SmallModule_3: 1212. In this case, for SmallModule_1: 1202, SmallModule_3: 1212 is a result of inferring of a similar part of a related machine or the like (using a reasoner or the like).

In addition, DWG_1: 1213 illustrated in the example of part (b) of FIG. 12 is a result of inferring of a drawing class by mapping using an ontology, and corresponds to SmallModule_3: 1212. Then, What 1: 1214 is a result of inference from a mapped ontology, and corresponds to DWG_1: 1213. In addition, Part_7: 1217 and Part_8: 1218 are results of inferring related parts using a product class (the example illustrated in FIG. 8), and correspond to SmallModule_3: 1212. In addition, What_2: 1220 to Attribute_4: 1227 are results of application of rules to When_1: 1216, detection of When_2: 1222, inferring of a related operation from a combination of rules made by treating operations performed within a predetermined period as the same operations, and deriving of other access content.

That is, as a result of matching performed with a structured log, part (b) of FIG. 12 is output as knowledge (know-how) to an operator who develops SmallModule_1: 1202. In addition, part (b) of FIG. 12 is not a simple log but structured, and has a structure added by (inferred from) other ontologies and rule classes. In addition, as described above, documents and the like the operator who develops SmallModule_1: 1202 is unable to access may be removed from part (b) of FIG. 12.

In the above-described examples, examples are illustrated in which a description of object definitions (classes) (schema) has been generated in advance; however, machine learning may be applied to logs and object definitions may be generated.

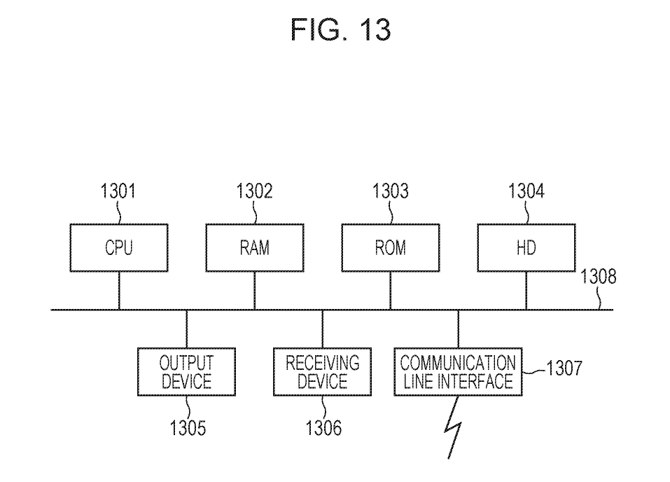

Note that a hardware configuration of a computer by which a program serving as a present exemplary embodiment is executed is, as illustrated in FIG. 13, that of a general computer and is specifically that of a personal computer, a computer that could be a server, or the like. That is, as a specific example, a CPU 1301 is used as a processing unit (an arithmetic unit), and a RAM 1302, a ROM 1303, and a HD 1304 are used as a storage device. As the HD 1304, for example, a hard disk may also be used. The computer includes the CPU 1301, the RAM 1302, the ROM 1303, the HD 1304, an output device 1305, a receiving device 1306, a communication line interface 1307, and a bus 1308. The CPU 1301 executes programs such as the operation log extraction module 110, the structuring module 120, the machine learning module 140, the output module 150, and the like. The programs and data are stored in the RAM 1302. Programs and the like for starting up the computer are stored in the ROM 1303. The HD 1304 is an auxiliary storage device (may also be a flash memory or the like). The receiving device 1306 receives data in accordance with a user's operation through a keyboard, a mouse, a touch panel, or the like. The output device 1305 is a CRT, a liquid crystal display, or the like. The communication line interface 1307 is an interface for connection to a communication network, such as a network interface card or the like. The bus 1308 connects the CPU 1301, the RAM 1302, the ROM 1303, the HD 1304, the image output device 1305, the receiving device 1306, and the communication line interface 1307 to each other and is a bus for data exchange. Plural such computers may be connected to each other through a network.

One of the above-described present exemplary embodiments, which is about the computer program, is realized by causing a system having the hardware configuration to read the computer program, which is software, and causing software and hardware resources to cooperate.

Note that the hardware configuration illustrated in FIG. 13 is an exemplary configuration. The present exemplary embodiment is not limited to the configuration illustrated in FIG. 13, and has only to have a configuration that may execute the modules described in the present exemplary embodiment. For example, some of the modules may be configured using a dedicated hardware device (for example, an ASIC or the like). Some of the modules may be provided in an external system and connected through communication lines. Furthermore, plural such systems illustrated in FIG. 13 may be connected to each other through communication lines and may operate in a cooperation manner. In addition, in particular, the modules may be installed not only in a personal computer but also in a home information appliance, a copier, a facsimile, a scanner, a printer, a multifunction machine (an image processing apparatus having two or more functions of a scanner, a printer, a copier, a facsimile, and the like), and the like.

Note that the program that has been explained may also be stored in a recording medium and provided. Furthermore, the program may also be provided using communication means. In that case, for example, the program explained above may also be considered as an invention that is a “computer readable recording medium in which a program is recorded”.

The “computer readable recording medium in which a program is recorded” is a non-transitory computer readable recording medium used for installation, execution, and distribution of the program and in which the program is recorded.

Note that examples of the recording medium include a digital versatile disc (DVD), a compact disc (CD), a Blu-ray disc (Blu-ray® Disc), a magneto-optical disk (MO), a flexible disk (FD), a magnetic tape, a hard disk, a read-only memory (ROM), an electrically erasable programmable ROM (EEPROM®), a flash memory, a random access memory (RAM), an SD (Secure Digital) memory card, and the like. DVDs include “a DVD-R, a DVD-RW, a DVD-RAM, and the like” for standards developed by the DVD forum and “a DVD+R, a DVD+RW, and the like” for standards developed by DVD+RW. CDs include a compact disc-read-only memory (CD-ROM), a CD recordable (CD-R), a CD-Rewritable (CD-RW), and the like.

The above-described program or a portion of the program may be recorded and saved in the above-described recording medium, distributed, or the like. The above-described program or a portion of the program may be transmitted by communication, for example, through a wired network, a wireless communication network, or a transmission medium such as a combination of a wired network and a wireless communication network or the like. Alternatively, the above-described program or a portion of the program may also be transferred by a carrier wave. Examples of the wired network include a local-area network (LAN), a Metropolitan Area Network (MAN), a wide area network (WAN), the Internet, an intranet, an extranet, and the like.

Furthermore, the above-described program may be a portion of another program or may also be recorded in a recording medium together with a separate program. In addition, the above-described program may also be divided and recorded in plural recording mediums. In addition, the above-described program may be recorded in any format such as a compressed format, an encrypted format and the like, as long as the above-described program may be reconstructed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a structuring unit that structures a history of operations performed in product development into a structure including at least subject information, subject attribute information, target information, target attribute information, and environment information; and
an extraction unit that extracts knowledge about the operations by performing machine learning based on the structured history.

2. The information processing apparatus according to claim 1, wherein
the structuring unit performs structuring using an ontology and a temporary rule.

3. The information processing apparatus according to claim 1, wherein
the structuring unit performs structuring such that information indicating whether a first operator as a subject is able to access a target is included, and
in a case where the extraction unit extracts knowledge to be provided to a second operator, who differs from the first operator, the extraction unit extracts the knowledge from the structured history such that a relationship with a target that the second operator is unable to access is not included in the knowledge.

4. The information processing apparatus according to claim 2, wherein
the structuring unit performs structuring such that information indicating whether a first operator as a subject is able to access a target is included, and
in a case where the extraction unit extracts knowledge to be provided to a second operator, who differs from the first operator, the extraction unit extracts the knowledge from the structured history such that a relationship with a target that the second operator is unable to access is not included in the knowledge.

5. A non-transitory storage medium storing an information processing program for causing a computer to function as:
a structuring unit that structures a history of operations performed in product development into a structure including at least subject information, subject attribute information, target information, target attribute information, and environment information; and
an extraction unit that extracts knowledge about the operations by performing machine learning based on the structured history.

6. An information processing method comprising:
structuring a history of operations performed in product development into a structure including at least subject information, subject attribute information, target information, target attribute information, and environment information; and
extracting knowledge about the operations by performing machine learning based on the structured history.
